(19) United States
(12) Patent Application Publication
(10) Pub. No.: US 2023/0322397 A1
(43) Pub. Date: Oct. 12, 2023

(54) CHARGE STATUS CONTROL SYSTEM, CHARGE STATUS CONTROL METHOD, AND AIRCRAFT

(71) Applicant: HONDA MOTOR CO.,LTD., Tokyo (JP)

(72) Inventor: Yuya ISHIHARA, Saitama (JP)

(21) Appl. No.: 18/188,484

(22) Filed: Mar. 23, 2023

(30) Foreign Application Priority Data
Mar. 29, 2022 (JP) 2022-054685

(51) Int. Cl. B60L 58/25; B64D 27/24; H01M 10/625; B60L 58/13

(52) U.S. Cl. CPC B64D 27/24; B60L 58/13; B60L 58/25; H01M 10/625; B60L 2200/10; B64U 50/19

(57) ABSTRACT

A charge status control system 99 includes: a power generator 40a configured to generate electrical power and to supply it to a load; a battery 32 configured to store the electrical power generated by the power generator 40a and to supply the stored electrical power to the load; an ECU 33 configured to detect a state of charge of the battery 32; and a control unit 91 configured to, if a detection result of a remaining charge amount of the battery 32 by the ECU 33 is a storage threshold or more, control the state of charge of the battery 32 by discharging the electrical power stored in the battery 32 to an external power source 111. According to this, the remaining charge amount of the battery 32 can be maintained to approximately the storage threshold or less to suppress the progression of the deterioration of the battery 32.

### CROSS-REFERENCE TO RELATED APPLICATIONS

The contents of the following Japanese patent application(s) are incorporated herein by reference:

NO. 2022-054685 filed in JP on Mar. 29, 2022

### BACKGROUND

### 1. Technical Field

The present invention relates to a charge status control system, a charge status control method, and an aircraft.

### 2. Related Art

Conventionally, there is known a vertical take-off and landing type aircraft (also referred to as a VTOL aircraft, or simply an aircraft) that performs takeoff/landing by ascending/descending in a vertical direction by using a plurality of takeoff/landing (VTOL) rotors arranged at left and right sides of a fuselage, and flies in a horizontal direction by using a cruising rotor arranged at a rear part of the fuselage. In such an aircraft, a power generator charges a battery with electrical power generated by an engine, and the electrical power charged in this battery is utilized to operate a plurality of rotors and thereby the aircraft flies. Patent Document 1 discloses a thermal management system of an aircraft for supplementing a charge amount of a battery by an external power source until the next flight, and controlling its temperature to moderate temperature.

### Prior Art Document

### Patent Document

Patent Literature 1: US Pat. 2021/0170908

### BRIEF DESCRIPTION OF THE DRAWINGS

FIG. 1 illustrates a configuration of an aircraft according to the present embodiment in a top view.

FIG. 2 illustrates a configuration of a high voltage system and a configuration of a communication system.

FIG. 3 illustrates a functional configuration of a charge status control system.

FIG. 4 illustrates a flow of a charge status control method according to the present embodiment.

FIG. 5 illustrates an example of operation of the charge status control system.

FIG. 6A illustrates a state of transfer of electrical power in the charge status control system ((1) an operational state of battery discharge and a temperature control system).

FIG. 6B illustrates a state of transfer of electrical power in the charge status control system ((2) an operational state of the temperature control system during soak mode).

FIG. 6C illustrates a state of transfer of electrical power in the charge status control system ((3) a state of starting an engine).

FIG. 6D illustrates a state of transfer of electrical power in the charge status control system ((4) a state after actuating the engine).

FIG. 7 illustrates an example of a temporal transition of the state of charge of the battery.

### DESCRIPTION OF EXEMPLARY EMBODIMENTS

Hereinafter, the present invention will be described through embodiments of the invention, but the following embodiments are not for limiting the invention according to the claims. In addition, not all of the combinations of features described in the embodiments may be essential to the solution of the invention.

In the present specification, the phrases “or more” and “more than” may be interchangeable. In addition, the phrases “or less” and “less than” may be interchangeable.

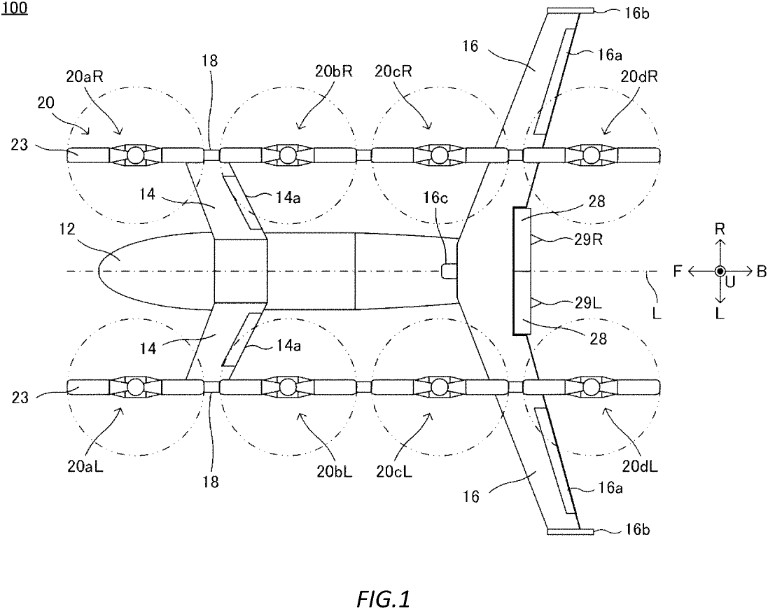

In FIG. 1, a configuration of an aircraft 100 according to the present embodiment is shown in a top view. The aircraft 100 includes a rotor having an electric motor as its driving source, is a vertical take-off and landing aircraft configured to perform take-off and landing in a vertical direction by using rotors for vertical take-off and landing (also referred to as VTOL rotors) 20 to generate thrust, and to fly in a horizontal direction by using cruising rotors (also referred to as cruise rotors) 29 to generate thrust, and is also a hybrid aircraft configured to be able to operate the electric motor utilizing high voltage power generated by a power generator 40a (an engine 44 and a motor generator 42) and high voltage power charged in a high voltage battery (also referred to as simply a battery) 32 and to charge the battery 32 with the engine 44.

The aircraft 100 according to the present embodiment is configured to, for example, during parking of the aircraft 100, discharge the battery 32 to maintain a remaining charge amount to a storage threshold or less to be able to suppress the progression of the deterioration of the battery 32, and the aircraft 100 includes a fuselage 12, front wings 14, rear wings 16, two booms 18, eight VTOL rotors 20, two cruising rotors 29, a temperature control system 70, a high voltage system 40, a communication system 49, and a charge status control system 99.

The fuselage 12 is a structure body for providing space for crews and passengers to board and for loading cargoes or the like, and for storing devices such as the battery 32, the motor generator 42, and the engine 44. The fuselage 12 is symmetric about a central axis L, and has a shape that extends in a front-back direction that is parallel to the central axis L and is narrow in the left-right direction that is orthogonal to the central axis L in the horizontal plane. Here, the direction parallel to the central axis L is defined as the front-back direction, in which the left side of the drawing and the right side of the drawing are respectively the front (F) and back (B), and the direction orthogonal to the central axis L in the horizontal plane is defined as the width direction (or the left-right direction), in which the upper side of the drawing and the lower side of the drawing are respectively the right (R) and left (L). In addition, the vertical direction is orthogonal to each of these front-back direction and the width direction, in which the upward and downward in the vertical direction are also respectively referred to as upper (U) and lower (L). The fuselage 12 has a front end with a round curvature in a top view, and a rear end parallel to the width direction that is tapered to some extent with respect to the barrel portion.

The front wing 14 is a wing body provided to extend laterally from the fuselage 12, and configured to generate lift during cruising, i.e., by moving forward, and functions as a canard of the aircraft 100. The front wing 14 has a V-shape with two wing bodies respectively extending from the center portion to the front-left direction and the front-right direction, and is fixed on the upper portion of the front side of the barrel portion of the fuselage 12 at the center portion with the opening of the V-shaping facing toward the front. The front wing 14 includes elevators 14a arranged in a rear edge on each of the two wing bodies.

The rear wing 16 is a wing body provided to extend laterally from the fuselage 12, and configured to generate lift during cruising, i.e., by moving forward, and functions as a swept-back wing configured to reduce air resistance. The rear wing 16 has a V-shape in which two wing bodies extend from a center portion to the left rear and the right rear, respectively, and is fixed at the center portion on the upper portion of the rear end of the fuselage 12 via a pylon 16c with the V-shaped opening being directed toward the rear. The rear wing 16 includes elevons 16a arranged in a rear edge on each of the two wing bodies and vertical tail wings 16b arranged at tips of the wings.

Here, a wing area of the rear wing 16 is greater than that of the front wing 14, and a wing width of the rear wing 16 is wider than that of the front wing. In this manner, the lift generated by the rear wing 16 by moving forward is greater than the lift generated by the front wing 14, and the rear wing 16 functions as a main wing of the aircraft 100. Note that, the wing areas, the lengths or the like of the front wing 14 and the rear wing 16 may be decided based on the balance of the lift generated by each wing, the position of the center of gravity, the posture of the aircraft body during cruising, and the like.

The two booms 18 are structures that are each spaced apart from the fuselage 12 in the left-right direction and supported by the front wing 14 and the rear wing 16, and perform a function of supporting or storing each component of the VTOL rotor 20. The two booms 18 each have a cylindrical shape extending in the front-back direction in a top view and a wing-shaped cross section with the upper side having a round curvature and the lower side tapered in a front view, and are paired to be arranged symmetrically with respect to the fuselage 12 (i.e., the central axis L). Note that, the two booms 18 may be formed to extend in the front-back direction and to have an arch-shape curvature in the width direction. The two booms 18 each have a front end positioned ahead of the front wing 14, are each supported on a tip end of the front wing 14 by a front barrel portion (between the two VTOL rotors 20aL and 20bL on the front side and between the two VTOL rotors 20aR and 20bR on the front side), each have a rear end positioned behind the rear wing 16 and are each supported on the rear wing 16 by a rear barrel portion (between the two VTOL rotors 20cL and 20dL on the rear side and the two VTOL rotors 20cR and 20dR on the rear side).

The eight VTOL rotors 20 (20aL to 20dL, 20aR to 20dR) are an example of a load that is supplied with electrical power generated by the power generator 40a, and are supported by the two booms 18 to constitute a propulsion system for generating thrust in the vertical direction at the time of take-off and landing. Four VTOL rotors 20aL to 20dL of the eight VTOL rotors 20 are supported by the left boom 18 at generally equal intervals, and the remaining four VTOL rotors 20aR to 20dR are supported by the right boom 18 at generally equal intervals. Here, the VTOL rotors 20aL to 20dL on the left side are sorted such that the VTOL rotor 20aL is arranged foremost, the two VTOL rotors 20bL and 20cL are arranged respectively on the frontside and the rearside between the front wings 14 and the rear wings 16, and the VTOL rotor 20dL is arranged rearmost. Similarly, the VTOL rotors 20aR to 20dR on the right side are sorted such that the VTOL rotor 20aR is arranged foremost, the two VTOL rotors 20bR and 20cR are arranged respectively on the frontside and the rearside between the front wings 14 and the rear wings 16, and the VTOL rotor 20dR is arranged rearmost. Among the VTOL rotors 20aL to 20dL on the left side and the four VTOL rotors 20aR to 20dR on the right side, each two left and right VTOL rotors 20aL, 20aR, VTOL rotors 20bL, 20bR, VTOL rotors 20cL, 20cR, and VTOL rotors 20dL, 20dR, which are located at the same position in the front-back direction, form a pair, and are controlled to rotate in reverse directions from each other.

Note that, unless otherwise specified, each of the eight VTOL rotors 20aL to 20dL and 20aR to 20dR is simply referred to as a VTOL rotor 20.

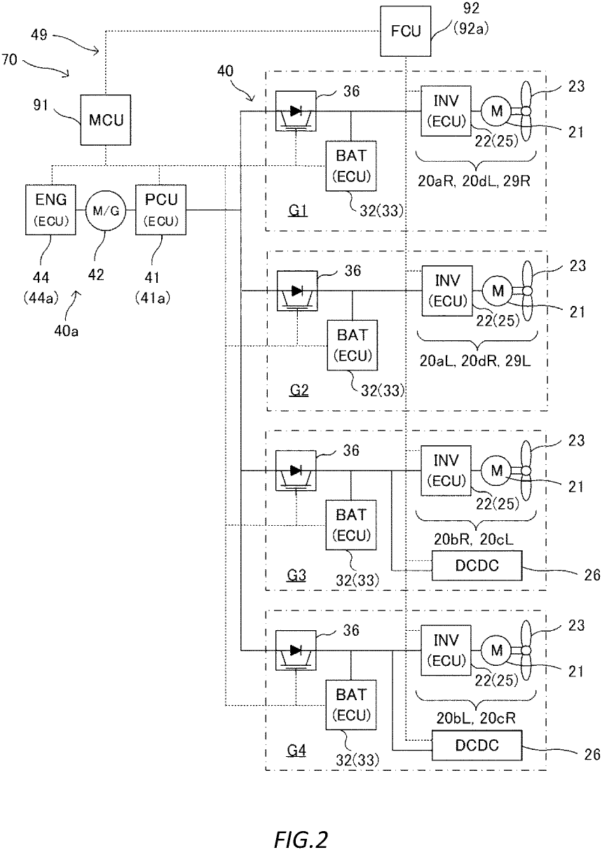

The VTOL rotor 20 has one or more blades 23, a motor 21, an inverter 22, and an ECU 25 (see FIG. 2).

The one or more blades 23 are blade-shaped members that are supported on the boom 18 and configured to rotate to generate a thrust in the vertical direction. In the present embodiment, the number of blades 23 is two, but may be any number including one or three or more. The one or more blades 23 are supported at positions higher than the front wing 14 and the rear wing 16. Note that, in FIG. 1, the plane of rotation of the one or more blades 23 of each VTOL rotor 20 is illustrated by using two-dotted lines.

The motor 21 is an electric motor that has a rotation shaft (not shown) directed in the upper-lower direction and is configured to rotate the blade 23 fixed to the motor 21 via a transmission (not shown) for converting the rotation speed of the rotation shaft. The motor 21 is accommodated in the boom 18.

The inverter 22 is a device configured to receive supply of DC power from the battery 32 via the high voltage system 40, to convert the DC power into AC power by driving (on/off) a switching device according to a drive signal received from the ECU 25 and to supply the AC power to the motor 21, and is accommodated in the boom 18 together with the motor 21. The inverter 22 can control rotational torque and a rate of rotation of the motor 21 respectively by increasing and decreasing the amplitude and frequency of the AC power.

The electronic control unit (ECU) 25 is a unit configured to control the operation of the inverter 22 by transmitting a drive signal to it to modulate the amplitude and the frequency of AC power, and to manage a power state input into the inverter 22. In the present embodiment, the ECU 25 is equipped in the inverter 22. The ECU 25 is implemented by a microcontroller as an example, operates by stepping down high voltage DC power from the battery 32 into low voltage DC power by a DC-DC converter 26 described below and receiving it via a low voltage system (also referred to as a LVS), and shows a control function by executing a dedicated program stored in a memory. Note that, a low voltage battery independent from the battery 32 may be provided within the aircraft body, and configured to supply the ECU 25 with low voltage DC power. Here, the power state input into the inverter 22 includes at least a voltage applied across an input terminal of the inverter 22 (also referred to as a voltage between terminals), current flowing into the input end, and a product of them (that is, electrical power). The ECU 25 is configured to detect the power state input into the inverter 22, and to transmit the detection result to a flight controller 92.

Two cruising rotors 29 (29L and 29R) are an example of a load that is supplied with electrical power generated by the power generator 40a, and are supported by the fuselage 12 at the back end to constitute a propulsion system for generating the thrust during cruising (see FIG. 2). The cruising rotors 29L and 29R include one or more blades 23 that are arranged alongside each other on the left and right sides relative to the central axis L within cylindrical ducts 28 fixed on the fuselage 12 at the back end, and that are supported by the ducts 28, and configured to generate forward thrust by being rotated; motors 21 that have rotation shafts oriented in the front-back direction, and configured to rotate the one or more blades 23 fixed at the tip of the shafts via the rotation shafts; the inverters 22 configured to receive DC power-supplying from the batteries 32 and convert it to AC power to be supplied to the motor 21; and the ECUs 25 configured to control the operations of the inverters 22. The inverter 22 can control the rate of rotation of the motor 21. Each of these components is configured similar to that of the VTOL rotor 20.

Note that, unless otherwise specified, each of the two cruising rotors 29L and 29R is simply referred to as a cruising rotor 29. In addition, unless otherwise specified, the VTOL rotor 20 and the cruising rotor 29 are collectively referred to as rotors 20 and 29.

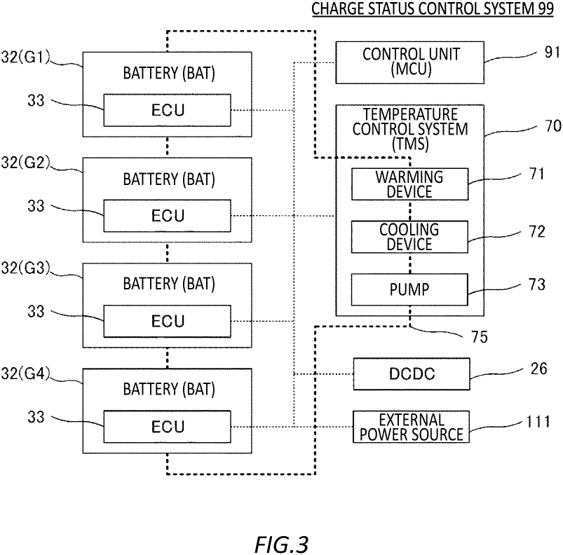

The temperature control system 70 is an example of a temperature conditioner, and is a system for controlling a temperature of the battery 32 described below by warming, cooling, and keeping the temperature of the battery 32. The temperature control system 70 includes a warming device 71, a cooling device 72, and a pump 73 (see FIG. 3). Note that, the temperature control system 70 is able to operate with low voltage DC power obtained by stepping down, via a DC-DC converter 26 described below, high voltage power from the battery 32 and supplying it via the low voltage system, and low voltage DC power supplied from an external power source 111.

The warming device 71 is a device controlled by the control unit 91, and is configured to warm and keep the temperature of the battery 32 by utilizing the low voltage DC power supplied from the battery 32 and the external power source 111. An electric coolant heater (ECH) may be adopted for the warming device 71, which is configured to warm and keep the temperature of an object by utilizing electricity to heat water and circulating it through the object. Although one warming device 71 may be provided for all the batteries 32, it is not intended to be limited thereto, and one may be provided for multiple batteries 32, or one may be provided for each battery 32. Note that, the warming device 71 may be also used for air conditioning of the interior of the aircraft body.

The cooling device 72 is a device controlled by the control unit 91, and is configured to cool the battery 32 by utilizing low voltage DC power supplied from the battery 32 and the external power source 111. As the cooling device 72, a device may be adopted including: a compressor configured to pressurize a refrigerant to be a high temperature gas; a first heat exchanger configured to cool the gaseous refrigerant having high temperature and high pressure to liquefy it; a decompressor configured to decompress the liquid refrigerant into low temperature liquid; a second heat exchanger configured to conduct a heat exchange using the liquid refrigerant having low temperature to cool water; and a pump configured to circulate the refrigerant among the compressor, the first heat exchanger, the decompressor, and the second heat exchanger via pipings. The cooling device 72 is configured to circulate the cooled water to cool the object. Although one cooling device 72 may be provided for all the batteries 32, it is not intended to be limited thereto, one may be provided for multiple batteries 32, or one may be provided for each battery 32. Note that, the cooling device 72 may be also used for air conditioning of the interior of the aircraft body.

The pump 73 is a device controlled by the control unit 91, and is configured to circulate water among the warming device 71, the cooling device 72, and four batteries 32. The warming device 71, the cooling device 72, and the four batteries 32 are connected in series via a piping 75, and the batteries 32 are warmed, kept the temperature thereof, or cooled by heating water by the warming device 71 or cooling it by the cooling device 72 and sending it to the four batteries 32. Note that, any medium other than water may be used.

In FIG. 2, a configuration of a high voltage system (also referred to as a power distribution system (PDS)) 40 and a configuration of a communication system 49 are shown.

The high voltage system 40 is configured to include a set of a power generator 40a and four group components G1 to G4. Note that, each component is connected via a power line (a power cable indicated in solid line).

The power generator 40a is a power source configured to generate electricity by using the engine 44 based on a target power-generating amount and to supply loads with the generated electrical power, and is configured to include the engine (ENG) 44, a motor generator (M/G) 42, and a power control unit (PCU) 41.

The engine 44 is an internal combustion engine such as a reciprocating engine and a gas-turbine engine. The engine 44 is configured to generate rotational power, and to output it to the motor generator 42. The engine 44 is controlled by the ECU 44a equipped therewith.

The ECU 44a is a unit configured to control the power generation by operating the engine 44 based on the target power-generating amount received from the control unit 91. The ECU 44a is implemented by a microcontroller as an example, operates by stepping down high voltage DC power from the battery 32 into low voltage DC power by the DC-DC converter 26 described below and receiving it via a low voltage system, and shows the control function by executing a dedicated program stored in the memory. Note that, a low voltage battery independent from the battery 32 may be provided within the aircraft body, and configured to supply the ECU 44a with low voltage DC power.

The motor generator 42 is a motor generator that is configured to work as a starter when starting the engine 44, and to work as a generator after starting the engine 44. The rotation shaft of the motor generator 42 is coupled to the output shaft of the engine 44. The motor generator 42 is configured to receive motive power of the engine 44 to generate electricity, that is, AC power (in particular, three-phase AC power) and output it to the PCU 41, and then, supply the generated electrical power to loads (that is, the VTOL rotors 20 and the cruising rotors 29 for generating thrust for flying) via the PCU 41. In addition, the motor generator 42 is configured to, at the time of starting the engine 44, receive AC power, generate rotational power, and output it the engine 44.

The PCU 41 is an electrical power conversion unit that is configured to use the inverter circuit to convert AC power input from the primary side (in particular, three-phase AC power) into DC power to output it to the secondary side as well as to convert DC power input from the secondary side into AC power (in particular, three-phase AC power) to output it to the primary side. The primary side terminal of the PCU 41 is connected to the motor generator 42, and the secondary side terminal is connected to each of the four group components G1 to G4. The PCU 41 is able to convert AC power output from the motor generator 42 into DC power to output it toward each of the four group components G1 to G4, and to convert DC power supplied from the batteries 32 included in the four group components G1 to G4 into AC power to output it to the motor generator 42. The PCU 41 is controlled by the ECU 41a equipped therewith.

The ECU 41a is an example of a control unit, and is a unit configured to control the power generation by operating the PCU 41 based on the target power-generating amount received from the control unit 91. The ECU 41a is implemented by a microcontroller as an example, operates by stepping down high voltage DC power from the battery 32 into low voltage DC power by the DC-DC converter 26 described below and receiving the low voltage DC power via a low voltage system, and shows the control function by executing a dedicated program stored in a memory. Note that, a low voltage battery independent from the battery 32 may be provided within the aircraft body, and configured to supply the ECU 41a with low voltage DC power.

The four group components G1 to G4 are electrical component groups each assembled including any two of the eight VTOL rotors 20, further any one of the two cruising rotors 29 for the group components G1 and G2, further one DC-DC converter 26 for the group components G3 and G4, and the battery 32 and the switch 36 attached thereto. Note that, these components including the batteries 32 are connected via circuit devices such as a power line (a power cable indicated in a solid line), a conductor, and a diode.

The group component G1 includes the VTOL rotors 20aR, 20dL, the cruising rotor 29R, the battery 32, and the switch 36.

As described above, the VTOL rotors 20aR, 20dL, and the cruising rotor 29R each include a motor 21 for rotating one or more blades 23, and a inverter 22 for receiving DC power-supplying from the battery 32 to convert it into AC power and supplying it the motor 21. These three rotors 20, 29 are connected in parallel to the battery 32. Note that, for the sake of simplicity, in FIG. 2, the VTOL rotors 20aR, 20dL, and the cruising rotor 29R are depicted as one rotor.

The battery 32 is an internal power source that is configured to store electrical power generated by the power generator 40a, supply the stored electrical power to the engine 44 to start it, and supply the same to the VTOL rotors 20 and the cruising rotors 29 (the motor 21 via the inverter 22) to operate them. Here, a state of charge of a battery (in particular, a remaining charge amount or a charging rate) is also referred to as State Of Charge (SOC). The battery 32 is connected between the three rotors 20, 29 and the switch 36 described above. The battery 32 is managed by the ECU 33 equipped therewith.

The ECU 33 is an example of a detection unit, and is a unit that is configured to manage the state of charge (SOC) of the battery 32. The ECU 33 is implemented by a microcontroller as an example, operates by stepping down high voltage DC power from the battery 32 into low voltage DC power by a DC-DC converter 26 described below and receiving it via a low voltage system, and shows the control function by executing a dedicated program stored in the memory. Note that, a low voltage battery independent from the battery 32 may be provided within the aircraft body, and configured to supply the ECU 33 with low voltage DC power. Here, the state of charge of the battery 32 includes at least a charge amount (a remaining charge amount, also referred to as the SOC), a discharge amount (a discharge power amount), temperature, and voltage of each cell constituting the battery 32. The ECU 33 is configured to detect the state of charge of the battery 32 in any way, such as detecting electrical current output from the battery 32 to calculate integrated amount of it, or detecting a potential of the output end. The detection result is transmitted to the control unit 91 via a communication line.

The switch 36 is a device for connecting and disconnecting the group component G1 to/from the secondary side terminal of the PCU 41, and as an example, is configured to include a rectifier device (a diode) and a switching device connected in parallel. The rectifier device is a device that allows only electrical power from the PCU 41 toward into the group component G1 to pass therethrough. The switching device is a device for short-circuiting both ends of the rectifier device, and a device such as, e.g., Insulated Gate Bipolar Transistor (IGBT) can be used. By turning off the switch 36 (the switching device), DC power output from the PCU 41 can be sent to the battery 32 and the three rotors 20 and 29 via the rectifier device, and by turning on the switch 36, the DC power can be sent from the battery 32 to the PCU 41 via the switching device.

Note that, since the switch 36 includes the rectifier device, it can be prevented that electrical power is supplied from a battery 32 within one group component of the four group components G1 to G4 to the other group components during the operation of the VTOL rotors 20 and the cruising rotors 29.

The group component G2 includes the VTOL rotors 20aL, 20dR, the cruising rotor 29L, the battery 32, and the switch 36. Each of these components is configured similar to that of the group component G1. Note that, for the sake of simplicity, in FIG. 2, the VTOL rotors 20aL, 20dR, and the cruising rotor 29L are depicted as one rotor.

The group component G3 includes the VTOL rotors 20bR, 20cL, the DC-DC converter 26, the battery 32, and the switch 36. Each of these components except the DC-DC converter 26 is configured similar to that of the group component G1. For the sake of simplicity, in FIG. 2, the VTOL rotors 20bR, 20cL are depicted as one rotor.

The DC-DC converter 26 is a device that is configured to step down high voltage power supplied from the power generator 40a and high voltage power (DC power) stored in the battery 32 to supply low voltage power to the temperature control system 70 (the warming device 71, the cooling device 72, and the pump 73), the external power source 111 or the like via a low voltage system. Note that, the low voltage power stepped down by the DC-DC converter 26 may be also used in electrical components of the low voltage system such as a control surface such as an elevator 14a, an elevon 16a, a display-related equipment within a cockpit, pitch angle changing mechanism of the blade 23 of the VTOL rotor 20, a cabin air conditioner via the low voltage system. The DC-DC converter 26 can adopt any type of converter such as a chopper converter, a flyback converter, a forward converter, as long as it is a step-down converter. The DC-DC converter 26, along with the VTOL rotors 20bR, 20cL, is connected in parallel to the battery 32.

The group component G4 includes the VTOL rotors 20bL, 20cR, the DC-DC converter 26, the battery 32, and the switch 36. Each of these components is configured similar to that of the group component G3. For the sake of simplicity, in FIG. 2, the VTOL rotors 20bL, 20cR are depicted as one rotor.

Note that, although the aircraft 100 according to the present embodiment includes a total of four batteries, one battery 32 for each of the four group components G1 to G4, but not limited thereto, the aircraft 100 may include any number of the batteries 32, such as a total of two batteries 32, one battery 32 for two of the four group components G1 to G4, or a total of eight batteries 32, two batteries 32 for each of the four group components G1 to G4. Also, the number of rotors within a group component may not be necessarily three, but each group component may comprise two rotors or four rotors. Besides, each group component may include one or more batteries 32.

The communication system 49 includes a flight controller (FCU) 92, a control unit (MCU) 91, an ECU 44a equipped in the engine 44, an ECU 41a equipped in a PCU 41, four switches 36 included in the group components G1 to G4, four ECUs 33 each connected to the batteries 32, and 10 ECUs 25 each connected to the inverters 22. These are communicatively connected to each other via the communication lines (communication cables indicated by dotted lines).

The flight controller 92 is a unit that is configured to receive a manipulate signal from a crew of the aircraft 100 via an interface 92a such as a joystick, a thrust lever to control operations of each component. The flight controller 92 is connected to each of the control unit 91 and the 10 ECUs 25 via the communication lines. The flight controller 92 is implemented by a microcontroller as an example, operates by stepping down high voltage DC power from the battery 32 into low voltage DC power by a DC-DC converter 26 and receiving it via a low voltage system, and shows the control function by executing a dedicated program stored in the memory. Note that, a low voltage battery independent from the battery 32 may be provided within the aircraft body, and configured to supply the flight controller 92 with low voltage DC power.

For example, when the flight controller 92 receives a command related to steering of the aircraft 100, a command for taking-off or cruising, or the like via the interface 92a, the flight controller 92 detects states (such as rotation speed of the blade 23, and a voltage between terminals of the inverter 22) of the VTOL rotors 20 and the cruising rotors 29 (that is, the loads) by the ECU 25, and based on those states, determines thrust (also referred to as a thrust command value) required for each of the VTOL rotors 20 and the cruising rotors 29, and an amount of power (that is, a target power-supplying amount) required to generate the thrust for each of them, and transmits them to the ECUs 41 and 44 via the control unit 91 to cause the power generator 40a to generate electrical power necessary for operating the rotors 20 and 29. At the same time, the flight controller 92 transmits the thrust command value (or rotation speed of the rotors 20 and 29 required for generating the thrust) to the ECU 25 to cause the switching device of the inverter 22 to operate, and then converts DC power output from the PCU 41 or DC power supplied from the battery 32 into AC power and outputs the AC power to the motor 21. Thereby, the motor 21 is actuated and the blade 23 rotates, allowing the VTOL rotors 20 and the cruising rotors 29 to generate the commanded thrust.

The control unit (MCU) 91 is a unit that is configured to conduct overall control of the control unit included in the communication system 49, and, for example, is configured to control the operation of the switching device of the switch 36 by communicating with the switch 36, the operation of the engine 44 by transmitting a target power-generating amount to the ECU 44a, and the operation of the switching device of the PCU 41 by transmitting the target power-generating amount to the ECU 41a, as well as to detect the state (in particular, the state of charge) of the battery 32 by communicating with the ECU 33. The control unit 91 is connected to each of the engine 44, the PCU 41, the four switches 36, and the four ECUs 33 via the communication lines. The control unit 91 is implemented by a microcontroller as an example, operates by stepping down high voltage DC power from the battery 32 into low voltage DC power by a DC-DC converter 26 and receiving it via a low voltage system, and shows the control function by executing a dedicated program stored in the memory. Note that, a low voltage battery independent from the battery 32 may be provided within the aircraft body, and configured to supply the control unit 91 with low voltage DC power.

The four ECUs 33 and 10 ECUs 25 are configured as described above.

In the high voltage system 40 and the communication system 49 configured as described above, when commanded to operate, for example, to start the engine, by a crew of the aircraft 100 via the flight controller 92, the control unit 91 is configured to turn on a switch 36 of at least one of the group components G1 to G4 to connect the battery 32 included in that group component to the PCU 41. Thereby, the electrical power charged by the battery 32 is supplied to the PCU 41. At this point, current may be controlled via a precharge circuit (not shown) to supply electrical power to the PCU 41. Therefore, the control unit 91 operates the PCU 41. The PCU 41 converts DC power supplied from the battery 32 into AC power to output it to the motor generator 42. Thereby, the motor generator 42 operates, and the engine 44 starts.

Once the engine 44 starts, the control unit 91 turns off the switch 36. In this state, the motor generator 42 receives motive power of the engine 44 to generate electrical power. The generated AC power is converted by the PCU 41 into DC power to supply it to each of the group components G1 to G4. Thereby, the VTOL rotors 20 and the cruising rotors 29 operate and the battery 32 is charged.

In FIG. 3, a functional configuration of a charge status control system 99 is shown. The charge status control system 99 is a system for controlling a state of charge of the battery 32, and is configured to include a control unit 91, a temperature control system (TMS) 70, a DC-DC converter 26, an external power source 111, and four ECUs 33 equipped in each of four batteries 32. Among them, the control unit 91, the temperature control system 70, the DC-DC converter 26, and the four ECUs 33 are configured as described above.

The external power source 111 is a low voltage power source installed outside the aircraft body, for example, in the area where the aircraft 100 is parked, such as a hangar that stores the aircraft 100. The external power source 111 is a power source of a low voltage system for supplying electricity to the temperature control system 70 (the warming device 71, the cooling device 72, and the pump 73) to cause them operate. By connecting the external power source 111 to the temperature control system 70 of the parked aircraft 100, power-supplying from the external power source 111 is utilized to operate the temperature control system 70 and to warm, cool, or keep temperature of the battery 32. Thereby, it is possible to maintain the temperature of the battery 32 to moderate temperature. At the departure of the aircraft 100, the external power source 111 is removed from the temperature control system 70.

The battery 32 starts the engine 44 and operates the VTOL rotors 20 and the cruising rotors 29 to store electrical power for causing the aircraft 100 to fly. The battery 32 needs to store the minimum charge amount required to start the engine 44 in doing so (also referred to as the startable charge amount, or the startable SOC), or the minimum charge amount required to operate the VTOL rotors 20 and the cruising rotors 29 to generate necessary thrust in causing the aircraft 100 to fly (also referred to as the flyable charge amount, or the flyable SOC). Note that, the startable charge amount is less than the flyable charge amount. In addition, since the battery 32 has a tendency to progress its deterioration if a remaining charge amount is large, it is desired to maintain the remaining charge amount to the storage threshold or less. Note that, the storage threshold is a threshold that gives the upper limit of the appropriate remaining charge amount to suppress the deterioration of the battery 32, and can be defined such that it is more than the startable charge amount and less than the flyable charge amount.

Therefore, in the charge status control system 99, the control unit 91 controls the state of charge of the battery 32 by discharging electrical power stored in the battery 32 to the external power source 111 if the detection result of the remaining charge amount of the battery 32 by the ECU 33 is the storage threshold or more. Thereby, the remaining charge amount of the battery 32 can be maintained to approximately the storage threshold or less to suppress the progression of the deterioration of the battery 32.

In addition, the performance of the battery 32 highly depends on its temperature. For example, the battery 32 outputs greater electrical power as it gets warmer, outputs less electrical power as it gets colder, and hardly outputs electrical power when it is frozen. Hence, the battery 32 needs to maintain its temperature to the temperature at which the minimum electrical power required to start the engine 44 can be output in doing so (also referred to as the startable temperature), or the temperature at which the minimum electrical power required to operate the VTOL rotors 20 and the cruising rotors 29 to generate necessary thrust can be output in causing the aircraft 100 to fly (also referred to as the flyable temperature). Note that, the startable temperature is lower than the flyable temperature.

Therefore, the control unit 91 controls the temperature state of the battery 32 by operating the temperature control system 70 based on the detection result of the temperature of the battery 32 by the ECU 33. Thereby, the temperature state of the battery 32 can be maintained to an appropriate temperature to start the power generator 40a, and can be maintained to an appropriate temperature to supply electrical power to the VTOL rotors 20 and the cruising rotors 29.

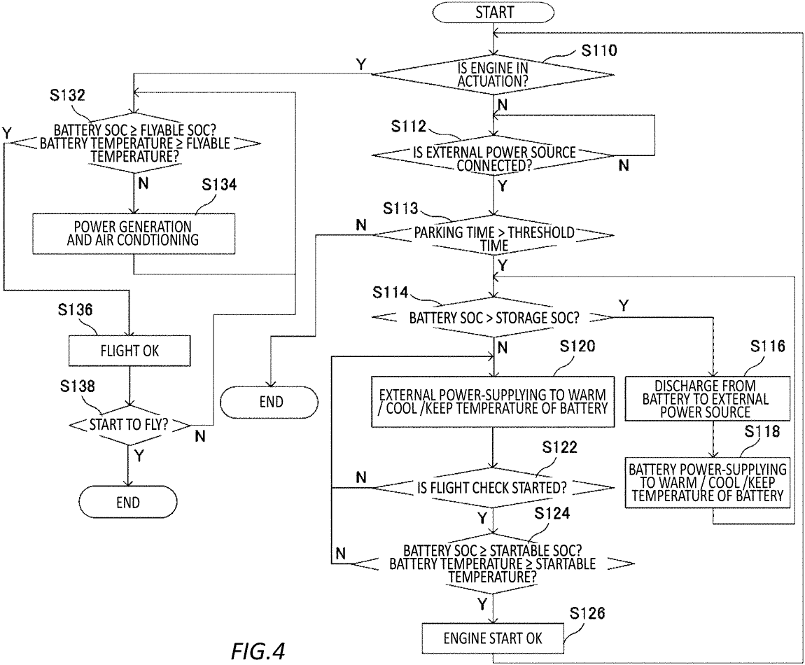

In FIG. 4, a flow of a charge status control method for controlling a state of charge of a battery 32 according to the present embodiment is shown. The present flow, for example, starts with storing an aircraft 100 in a hangar, and connecting an external power source 111 to the aircraft 100. Note that, self-discharge of the battery 32 is considered to be negligible.

In step S110, the control unit 91 determines whether an engine 44 is in actuation. If the engine 44 is in actuation, the flow proceeds to step S132, or if the engine 44 is stopped, the flow proceeds to step S112.

In step S112, the control unit 91 determines whether the external power source 111 is connected to the temperature control system 70 of the aircraft 100 and the DC-DC converter 26. Being connected or not can be determined by detecting whether electricity is supplied from the battery 32 to the external power source 111 or from the external power source 111 to a temperature control system 70 (or whether current is flowing). If the external power source 111 is connected, the flow proceeds to step S113, or if the external power source 111 is not connected, the flow repeats step S112.

In step S113, the control unit 91 determines whether parking time to the next flight, e.g., a period until start of a charging operation at the flight check to operate the power generator 40a and store electrical power in the battery 32, is longer than a threshold time. By obtaining a flight plan input by a crew via the interface 92a or a flight plan transmitted from an airport traffic control tower or the like, the control unit 91 can obtain the starting time of the charging operation at the flight check and the parking time from the flight plan.

Here, the threshold time can be determined from time required to transfer the electrical power stored in the battery 32 to the external power source 111 at a defined rate. For example, by dividing a difference between the remaining charge amount of the battery 32 and the storage threshold by an output rate of the DC-DC converter 26, the threshold time can be determined as time to discharge the battery 32 via the DC-DC converter 26 to decrease to the storage threshold. Therefore, the control unit 91 may set the threshold time to be longer as the detection result of the remaining charge amount of the battery 32 is greater.

In steps S114 to S126, the control unit 91 controls the state of charge of the battery 32, and utilizes power-supplying from the battery 32 or the external power source 111 to warm, cool, or keep temperature of the battery 32.

In step S114, the control unit 91 determines whether a remaining charge amount of the battery 32 (a battery SOC) is higher than a storage threshold (a storage SOC). The state of charge of the battery 32 is detected by the ECU 33, and the detection result is transmitted to the control unit 91. The control unit 91 can determine whether the remaining charge amount of the battery 32 is higher than the storage threshold based on the detection result received from the ECU 33. If the remaining charge amount of the battery 32 is more than the storage threshold, the flow proceeds to step S116, or if the remaining charge amount of the battery 32 is the storage threshold or less, the flow proceeds to step S120.

In step S116, the control unit 91 discharges the electrical power stored in the battery 32 to the external power source 111.

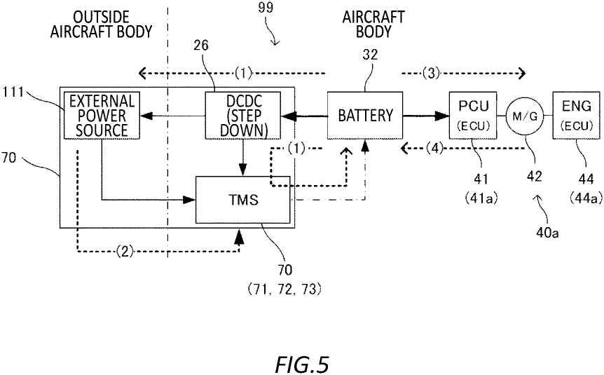

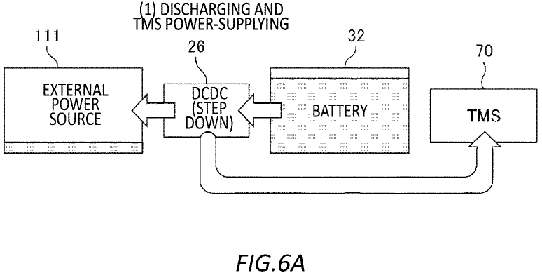

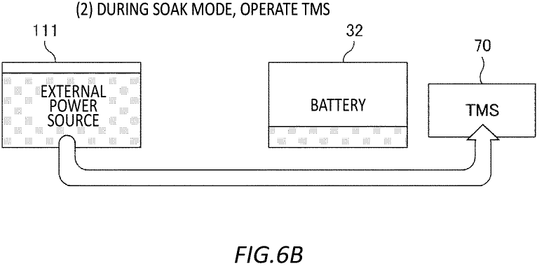

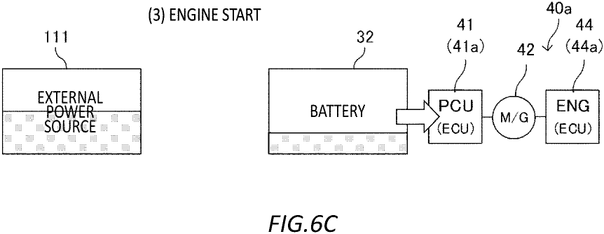

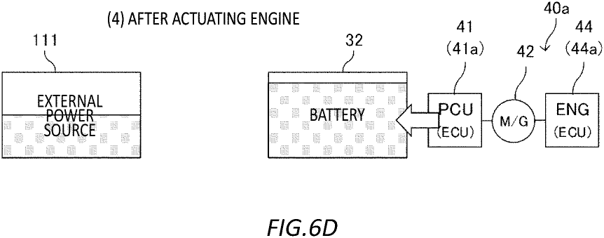

In FIG. 5, an operation of the charge status control system 99 is shown. The control unit 91, in response to the remaining charge amount of the battery 32 being higher than the storage threshold, (1) steps down the electrical power (DC power) stored in the battery 32 using the DC-DC converter 26 and discharges toward the external power source 111. Thereby, as shown in FIG. 6A, the remaining charge amount of the battery 32 decreases, and the charge amount of the external power source 111 increases.

In step S118, the control unit 91 supplies the electrical power stored in the battery 32 to the temperature control system 70 and operates it to warm, cool, or keep temperature of the battery 32. As shown in FIG. 5 and FIG. 6A, the control unit 91 (1) steps down the electrical power (DC power) stored in the battery 32 using the DC-DC converter 26 and supplies it to the temperature control system (TMS) 70.

Here, the temperature of the battery 32 is detected by the ECU 33, and the detection result is transmitted to the control unit 91. The control unit 91, based on the detection result received from the ECU 33, operates the warming device 71 to warm the battery 32 if the temperature of the battery 32 is lower than a startable temperature or a flyable temperature, operates the cooling device 72 to cool the battery 32 if the temperature of the battery 32 is higher than an upper temperature limit, or operates the warming device 71 to keep temperature of the battery 32 if the temperature of the battery 32 is moderate temperature. Here, the upper temperature limit of the battery 32 is an upper limit of the temperature below which the battery 32 functions properly, and is higher than the startable temperature and the flyable temperature. Thereby, the temperature of the battery 32 is maintained within a suitable temperature range.

Steps S116 to S118 are repeated until the discharge of the battery 32 progresses and the remaining charge amount decrease to the storage threshold or less and the determination of step S114 is affirmed. Thereby, the temperature state of the battery 32 is controlled while electrical power stored in the battery 32 being discharged toward the external power source 111.

If the discharge of the battery 32 progresses and the remaining charge amount decreases to the storage threshold or less and the start threshold or more required to start the power generator 40a, the determination of step S114 is affirmed and the flow proceeds to step S120, where the control unit 91 stops discharging to the external power source 111. It allows to maintain the remaining charge amount of the battery 32 to the storage threshold or less and the start threshold or more.

In step S120, the control unit 91 operates the temperature control system 70 by power-supplying from the external power source 111 to warm, cool, or keep temperature of the battery 32. As shown in FIG. 5 and FIG. 6B, the control unit 91 (2) supplies low voltage DC power stored in the external power source 111 to the temperature control system 70.

Here, the temperature of the battery 32 is detected by the ECU 33, and the detection result is transmitted to the control unit 91. The control unit 91, based on the detection result received from the ECU 33, operates the warming device 71 to warm the battery 32 if the temperature of the battery 32 is lower than a startable temperature or a flyable temperature, operates the cooling device 72 to cool the battery 32 if the temperature of the battery 32 is higher than an upper temperature limit, or operates the warming device 71 to keep temperature of the battery 32 if the temperature of the battery 32 is moderate temperature. Thereby, the temperature of the battery 32 is maintained within a suitable temperature range.

In step S122, the control unit 91 determines whether a flight check, which is conducted at the point of time a predetermined time before or after a scheduled departure time, is now being conducted. Here, the flight check includes all of a pre-flight check, a system check, and the flight check described below. However, the flight check may include at least one of them, such as the pre-flight check only. It can be determined whether the flight check is now being conducted, for example, by detecting a manipulation by a maintenance crew or a crew for the check via the interface 92a. Step S120 is repeated until the flight check is started, and once the flight check is started, the flow proceeds to step S124.

In step S124, the control unit 91 determines whether the remaining charge amount of the battery 32 is the startable charge amount or more and the temperature of the battery 32 is the startable temperature or higher. The state of charge of the battery 32 is detected by the ECU 33, and the detection result is transmitted to the control unit 91. The control unit 91 can determine the remaining charge amount and the temperature of the battery 32 based on the detection result received from the ECU 33. If the remaining charge amount of the battery 32 is the startable charge amount or more and the temperature of the battery 32 is the startable temperature or higher, the flow proceeds to step S126, or otherwise, step S120 is repeated until the determination of step S124 is affirmed.

Note that, in the determination of the remaining charge amount of the battery 32 in step S124, the startable charge amount may be replaced with an amount slightly higher than it as the threshold for use in order to ensure the startable charge amount is reserved. This also applies to other determination steps.

In step S126, the control unit 91 issues a signal that permits a crew of the aircraft 100 to start the engine 44. The signal can be expressed in light of a lamp, voice, a screen display or the like. The crew can recognize the signal, and start the engine 44 via the interface 92a. At this time, as shown in FIG. 5 and FIG. 6C, the control unit 91 (3) starts the power generator 40a by power-supplying from the battery 32, and after actuating the power generator 40a, as shown in FIG. 5 and FIG. 6D, (4) charges the battery 32 by supplying electricity from the power generator 40a.

Once the engine 44 is started, the determination of step S110 is affirmed, and the flow proceeds to step S132. In steps S132 to S138, the control unit 91 performs a procedure of recovering the state of the battery by the engine start.

In step S132, during actuating the engine 44, the control unit 91 further determines whether the remaining charge amount of the battery 32 is the flyable charge amount or more and the temperature of the battery 32 is the flyable temperature or higher. The remaining charge amount and the temperature of the battery 32 can be detected as described above. If the remaining charge amount of the battery 32 is the flyable charge amount or more and the temperature of the battery 32 is the flyable temperature or higher, the flow proceeds to step S136, or otherwise, the flow proceeds to step S134.

In step S134, the control unit 91 operates the temperature control system 70 by power-supplying from the power generator 40a (stepped down by the DC-DC converter 26) to warm, cool, or keep temperature of the battery 32. Here, the temperature of the battery 32 is detected by the ECU 33, and the detection result is transmitted to the control unit 91. The control unit 91, based on the detection result received from the ECU 33, operates the warming device 71 to warm the battery 32 if the temperature of the battery 32 is lower than a flyable temperature, operates the cooling device 72 to cool the battery 32 if the temperature of the battery 32 is higher than an upper temperature limit, or operates the warming device 71 to keep temperature of the battery 32 and charges the battery 32 if the temperature of the battery 32 is moderate temperature. Thereby, the temperature of the battery 32 is maintained within a suitable temperature range and the battery 32 is charged.

Note that, if the remaining charge amount of the battery 32 is the flyable charge amount or more, the control unit 91 operates the temperature control system 70 by power-supplying from the engine 44 (stepped down by the DC-DC converter 26) to warm or cool the battery 32. However, the battery 32 is not charged.

In step S136, since the remaining charge amount of the battery 32 is the flyable charge amount or more and the temperature of the battery 32 is flyable temperature or higher, the control unit 91 issues a signal that permits a crew of the aircraft 100 to cause the aircraft 100 to fly. The signal can be expressed in light of a lamp, voice, a screen display or the like. The crew can recognize the signal, and start to fly via the interface 92a.

Since the flow cannot proceed to step S136 unless the determination of step S132 is affirmed, if the remaining charge amount of the battery 32 is less than the flyable charge amount or if the temperature of the battery 32 is lower than the flyable temperature, the flight cannot be started.

In step S138, it is determined, by the control unit 91, whether the aircraft 100 has started to fly. The start of the flight can be detected by inputting by a crew a flight command via the interface 92a or detecting the operation of the rotors 20, 29. If the flight has not been started yet, the flow returns to step S132, and repeats steps S132 to S136. If the flight has been started, the flow S100 ends.

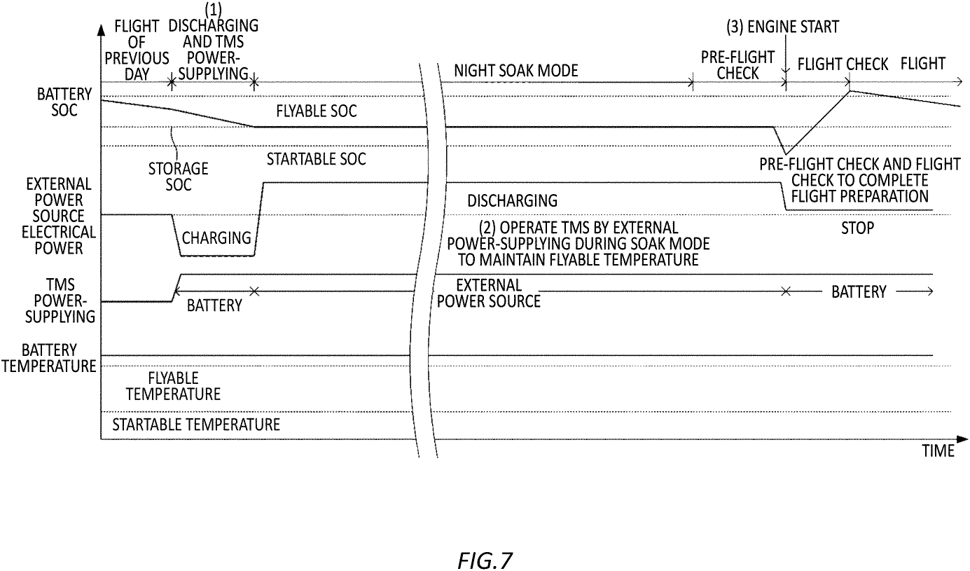

In FIG. 7, an example of a temporal transition of the state of charge of the battery 32 is shown. The aircraft 100 completes a flight schedule of the previous day, and is stored in the hangar. Subsequently, the engine 44 is stopped and the external power source 111 is connected to the temperature control system 70 of the aircraft 100 and the DC-DC converter 26 to enter a night soak mode.

In the present example, by the external power source 111 being connected after the stop of the engine 44, during the night soak mode, the determination of the step S110 in the flow S100 is negated, and the determination of the step S112 is affirmed, then the flow repeats steps S114 to S126. By Steps S116 to S118, (1) electrical power (DC power) stored in the battery 32 using the DC-DC converter 26 is stepped down to discharge it toward the external power source 111 and supply it to the temperature control system (TMS) 70, and operate the TMS 70 to warm, cool, or keep temperature of the battery 32. Thereby, the remaining charge amount (the SOC) of the battery 32 is decreased, the external power source 111 is charged.

Further, once the discharge of the battery 32 progresses and the remaining charge amount decreases to the storage threshold or less and the start threshold or more required to start the power generator 40a, in step S120, the control unit 91 stops discharging to the external power source 111, and (2) operates the temperature control system 70 by power-supplying from the external power source 111 to warm, cool, or keep temperature of the battery 32. It allows to maintain the remaining charge amount of the battery 32 to the storage threshold or less and the start threshold or more and the temperature of the battery 32 is maintained to moderate temperature (here, the flyable temperature or higher). Note that self-discharge of the battery 32 is considered to be negligible.

On the day of the flight, the pre-flight check, the system check, and the flight check of the aircraft are conducted at the point of time a predetermined time before a scheduled departure time. In the pre-flight check, for example, one maintenance crew conducts a check of equipment such as a fire extinguisher, a check of a power source system, a check of an exterior of the aircraft body, a check of sensors, a check of driving parts of the rotors 20, 29, a check of oil, cooling liquid, warming liquid or the like, a check of fuel, a check of the interface 92a or the like for e.g. about one hour.

The system check is a check conducted after the pre-flight check and before the flight, in which, for example, two crews conduct a check of the power source, a check of a warning sound, a check of a fuel system, a check of an air conditioning system, a check of the interface 92a such as a joystick or the like for a few minutes. After completion of the system check, a crew actuates the engine 44. Furthermore, rotation speed, temperature, pressure and the like of the engine 44, rotors 20, 29 are checked.

The flight check is the final check conducted right before the departure, in which for example, two crews conduct a check of warning and manipulation functionalities, a check of rotation speed, temperature, pressure or the like of the engine 44, rotors 20, 29 for one or two minutes. By completing the flight check, the flight can be started.

In the present example, the external power source 111 is removed from the aircraft 100 (the temperature control system 70) at the start of the flight check. Thereby, power-supplying from the external power source 111 is stopped, and is switched to power-supplying from the battery 32 to operate the temperature control system 70. Further, the determination of step S122 of the flow S100 is affirmed, and the flow proceeds to step S124. Here, by maintaining the remaining charge amount of the battery 32 to the startable charge amount or more and the temperature of the battery 32 to the startable temperature or higher, in step S126, the control unit 91 permits the engine 44 to start. In response to that, the crew starts the engine 44.

Once the engine is started, the determination of step S110 is affirmed, and the flow proceeds to step S132. Here, by maintaining the remaining charge amount of the battery 32 to the flyable charge amount or more and the temperature of the battery 32 to the flyable temperature or higher, the determination of step S132 is affirmed, and in step S136, the control unit 91 permits the flight. In response to that, after completion of the flight check, a crew manipulates the aircraft 100 to start the flight. Thereby, the determination of step S138 is affirmed, and the flow S100 ends.

A charge status control system 99 according to the present embodiment includes: a power generator 40a configured to generate electrical power and to supply it to a load; a battery 32 configured to store the electrical power generated by the power generator 40a and to supply the stored electrical power to the load; an ECU 33 configured to detect a state of charge of the battery 32; and a control unit 91 configured to, if a detection result of a remaining charge amount of the battery 32 by the ECU 33 is a storage threshold or more, control the state of charge of the battery 32 by discharging the electrical power stored in the battery 32 to an external power source 111. According to this, since, by the control unit 91, the battery 32 is charged by power-supplying from the power generator 40a, and if its remaining charge amount is the storage threshold or more, the electrical power stored in the battery 32 is discharged to the external power source 111, the remaining charge amount of the battery 32 can be maintained to approximately the storage threshold or less to suppress the progression of the deterioration of the battery 32.

Furthermore, the control unit 91 is configured to control the temperature state of the battery 32 by operating the temperature control system 70 based on the detection result of the temperature of the battery 32 by the ECU 33. According to this, since, by the control unit 91, the temperature control system 70 is operated by power-supplying from the battery 32 or power-supplying from the external power source 111 based on the temperature state of the battery 32, the temperature state of the battery 32 can be maintained to an appropriate temperature to start the power generator 40a and to supply electrical power to a load.

The aircraft 100 according to the present embodiment includes the charge status control system 99 described above, wherein the load is a propulsion system for generating thrust for flying. According to this, since, during parking of the aircraft 100, if its remaining charge amount of the battery 32 is the storage threshold or more, the electrical power stored in the battery 32 is discharged to the external power source 111, the remaining charge amount of the battery 32 can be maintained to approximately the storage threshold or less to suppress the progression of the deterioration of the battery 32.

A charge status control method according to the present embodiment includes: detecting a state of charge of a battery 32 configured to store electrical power supplied by a power generator 40a and to supply the stored electrical power to a load; and if the detection result of a remaining charge amount of the battery is a storage threshold or more, controlling the state of charge of the battery 32 by discharging the electrical power stored in the battery 32 to an external power source. According to this, since the battery 32 is charged by power-supplying from the power generator 40a, and if its remaining charge amount is the storage threshold or more, the electrical power stored in the battery 32 is discharged to the external power source 111, the remaining charge amount of the battery 32 can be maintained to approximately the storage threshold or less to suppress the progression of the deterioration of the battery 32.

While the embodiments of the present invention have been described above, the technical scope of the present invention is not limited to the above-described embodiments. It is apparent to persons skilled in the art that various alterations or improvements can be made to the above-described embodiments. It is also apparent from the description of the claims that the embodiments to which such alterations or improvements are made can be included in the technical scope of the present invention.

The operations, procedures, steps, and stages of each process performed by an apparatus, system, program, and method shown in the claims, specification, or drawings can be performed in any order as long as the order is not indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

What is claimed is:

1. A charge status control system for controlling a state of charge of a battery, comprising:
a power generator configured to generate electrical power and to supply the electrical power to a load;
a battery configured to store the electrical power generated by the power generator and to supply the stored electrical power to the load;
a detection unit configured to detect a state of charge of the battery; and
a control unit configured to, if a detection result of a remaining charge amount of the battery by the detection unit is a storage threshold or more, control the state of charge of the battery by discharging the electrical power stored in the battery to an external power source.

2. The charge status control system according to claim 1, further comprising:
a temperature conditioner configured to warm, cool, or keep temperature of the battery by each of power-supplying from the battery and power-supplying from the external power source,
wherein the detection unit is further configured to detect a temperature of the battery, and
wherein the control unit is configured to control a temperature state of the battery by operating the temperature conditioner based on the detection result of the battery by the detection unit.

3. The charge status control system according to claim 2, further comprising:
a transformer configured to step down electrical power of the battery to supply the electrical power to the temperature conditioner and the external power source.

4. The charge status control system according to claim 2, wherein the control unit is configured to, if a remaining charge amount of the battery is the storage threshold or more, discharge the electrical power stored in the battery to the external power source and to supply the electrical power to the temperature conditioner to operate the temperature conditioner.

5. The charge status control system according to claim 3, wherein the control unit is configured to, if a remaining charge amount of the battery is the storage threshold or more, discharge the electrical power stored in the battery to the external power source and to supply the electrical power to the temperature conditioner to operate the temperature conditioner.

6. The charge status control system according to claim 4, wherein the control unit is configured to, if a remaining charge amount of the battery decreases to the storage threshold or less and a start threshold or more required to start the power generator, stop discharging to the external power source.

7. The charge status control system according to claim 5, wherein the control unit is configured to, if a remaining charge amount of the battery decreases to the storage threshold or less and a start threshold or more required to start the power generator, stop discharging to the external power source.

8. The charge status control system according to claim 6, wherein the control unit is configured to, after stopping discharging to the external power source, operate the temperature conditioner by power-supplying from the external power source.

9. The charge status control system according to claim 8, wherein the control unit is configured to start the power generator by power-supplying from the battery, and to charge the battery by power-supplying from the power generator.

10. The charge status control system according to claim 1, wherein the control unit is configured to, if a period until starting time of a charging operation to operate the power generator and store electrical power in the battery is longer than a threshold time, control a state of charge of the battery.

11. The charge status control system according to claim 2, wherein the control unit is configured to, if a period until starting time of a charging operation to operate the power generator and store electrical power in the battery, is longer than a threshold time, control a state of charge of the battery.

12. The charge status control system according to claim 3, wherein the control unit is configured to, if a period until starting time of a charging operation to operate the power generator and store electrical power in the battery, is longer than a threshold time, control a state of charge of the battery.

13. The charge status control system according to claim 4, wherein the control unit is configured to, if a period until starting time of a charging operation to operate the power generator and store electrical power in the battery, is longer than a threshold time, control a state of charge of the battery.

14. The charge status control system according to claim 10, wherein the control unit is configured to set the threshold time to be longer as the detection result of the remaining charge amount of the battery is greater.

15. An aircraft comprising:
the charge status control system according to claim 1,
wherein the load is a propulsion system for generating thrust for flying.

16. An aircraft comprising:
the charge status control system according to claim 2,
wherein the load is a propulsion system for generating thrust for flying.

17. An aircraft comprising:
the charge status control system according to claim 3,
wherein the load is a propulsion system for generating thrust for flying.

18. An aircraft comprising:
the charge status control system according to claim 4,
wherein the load is a propulsion system for generating thrust for flying.

19. The aircraft according to claim 15, wherein the external power source is a low voltage power source installed outside an aircraft body.

20. A charge status control method for controlling a state of charge of a battery, comprising:
detecting a state of charge of a battery configured to store electrical power supplied by a power generator and to supply the stored electrical power to a load; and
if a detection result of a remaining charge amount of the battery is a storage threshold or more, controlling the state of charge of the battery by discharging the electrical power stored in the battery to an external power source.
